(19) United States
(12) Patent Application Publication
(10) Pub. No.: US 2019/0358901 A1
(43) Pub. Date: Nov. 28, 2019

(54) Oscillating Gate Powder Recoater for Three-Dimensional Printer

(71) Applicant: The ExOne Company, North Huntingdon, PA (US)

(72) Inventor: Anthony S. Dugan, McKeesport, PA (US)

(21) Appl. No.: 16/336,696

(22) PCT Filed: Sep. 25, 2017
(86) PCT No.: PCT/US17/53214

§ 371 Date: Mar. 26, 2019

Related U.S. Application Data
(60) Provisional application No. 62/404,730, filed on Oct. 5, 2016.

(51) Int. Cl. B29C 64/214; B22F 3/105; B29C 64/153; B33Y 30/00; B29C 64/329

(52) U.S. Cl. CPC B29C 64/214; B22F 3/1055; B22F 2003/1056; B33Y 30/00; B29C 64/329; B29C 64/153

(57) ABSTRACT

Powder-layer three-dimensional printer recoaters are disclosed which comprise a controllably vibrated traveling powder dispenser having a hopper section adapted to contain a build powder, an opening through which the powder can be controllably discharged laterally into a chamber which is located beside the opening and which has a mesh covering at least a portion of its bottom. A gate is located with its bottom portion proximal to the opening and is adapted so that its bottom portion horizontally oscillates with respect to the hopper. The recoaters also comprise a vibrator that is operably connected to the traveling powder dispenser and is adapted to selectively cause the powder to flow from the hopper through the opening and be discharged through the mesh and the bottom portion of the gate to horizontally oscillate. In some embodiments, the recoaters also comprise a smoothing device which is adapted to smoothen the powder dispensed through the mesh.

### BACKGROUND

### Field of the Invention

The present invention relates to powder recoaters adapted for use in three-dimensional printing and three-dimensional printers having such powder recoaters.

### Background of the Art

There are today various types of three-dimensional printers, i.e. devices that convert electronic representations of three-dimensional articles into the articles themselves by the systematic building-up of one or more materials. The device of the present invention finds particular utility with the types of three-dimensional printers which create three-dimensional articles by selectively binding together preselected areas of successively deposited layers of powder. These types of three-dimensional printers are referred to herein as “powder-layer three-dimensional printers” because the construction of the three-dimensional article by such printers utilizes layers of powders as a build material. Examples of such types of powder-layer three-dimensional printers include, without limitation, the binder-jet three-dimensional printers, the selective sintering three-dimensional printers, and the electron beam melting three-dimensional printers.

It is to be understood that the term “powder” is also sometimes referred to in the art as “particulate material” or “particles” and the term “powder” is to be construed herein as meaning any such material, by whatever name, that is used in such three-dimensional printers as a layer-forming material. Powder may comprise any type of material capable of taking on the powder form, e.g. metal, plastics, ceramics, carbon, graphite, composite materials, minerals, etc., and combinations thereof. The term “build powder” is used herein to refer to a powder which is used to form the powder layers and from which the article is built in a powder-layer three-dimensional printer.

During the operation of a powder-layer three-dimensional printer, a first layer of a build powder is deposited upon a vertically indexible build platform and then successive powder layers are deposited one at a time upon the first powder layer. Selected portions of selected powder layers are treated to bind the powders in those portions together as one or more three-dimensional articles are formed. Collectively, the portions of the deposited powder layers which are not bound together are referred to herein as a “powder bed.”

The process of forming a powder layer is sometimes referred to in the art, and is referred to herein, as “recoating”. The device or combination of devices of a particular powder-layer three-dimensional printer that accomplishes the recoating is sometimes referred to in the art, and is referred to herein, as a “powder recoater” or more simply as a “recoater.”

In some powder-layer three-dimensional printers, each powder layer is formed by transferring a predetermined quantity of build powder from an open-top stationary powder reservoir by first indexing upward a platform which supports the powder within the reservoir a predetermined amount to raise the predetermined quantity above the reservoir walls and then pushing that quantity of powder across the top of the build platform or the powder bed, e.g. by a doctor blade or a counter-rotating roller, to form a powder layer. Examples of such recoaters are described in U.S. Pat. No. 5,387,380 to Cima et al. Such recoaters are generally limited for use with relatively small size powder beds, i.e. those which having recoating direction lengths of under a few tens of centimeters.

In some powder-layer three-dimensional printers, each powder layer is deposited upon the build platform or upon an extant powder bed by a recoater comprising a traveling powder dispenser which dispenses a build powder through an open slit as it traverses across the build platform or powder bed. Examples of such recoaters are described in U.S. Pat. No. 7,799,253 B2 to Hochsmann et al. Such recoaters may or may not include some device which is adapted to smoothen the top of the powder layer. As used herein, the term “smoothen” is to be interpreted as meaning operating on a quantity of powder so as to do at least one of (a) form at least a portion of the quantity of powder into a layer, (b) make at least a portion of the surface of a layer comprising the quantity of powder less rough, and (c) compress at least a portion of a layer comprising the quantity of powder. A mechanism which smoothens a quantity of powder is referred to herein as a “smoothing device.”

Some powder-layer three-dimensional printers benefit from generally applying radiant energy to the powder bed, e.g. to adjust the temperature the powder bed, to assist in the volatilization of fugitive materials, e.g. the carrier or solvent portion of applied binder systems, from the powder bed, and/or to aid in curing one or more materials present within the powder bed. Accordingly, some makers of such powder-layer three-dimensional printers have found it expedient to mount the radiant energy source on the recoater. Doing so provides the radiant energy source with a controllable carriage for moving the radiant heat source across the powder bed, thus eliminating any need for a separate carriage system. In such arrangements, the radiant energy source can be operated at the same, overlapping, or different times from the operation of the recoater's powder dispensing mechanisms.

Recently, recoaters for powder-layer three-dimensional printers have been developed which discharge powder from a traveling powder dispenser which has a mesh, i.e. a screen or a sieve, attached to its side or bottom so that powder can be dispensed through the mesh onto the powder bed. Examples of such recoaters are described in U.S. Pat. No. 9,254,535 B2 to Buller et al. Such recoaters may or may not include a smoothing device.

A problem with many prior art recoaters which include traveling powder dispensers is that they are not well adapted for use with fine powders. Fine powders, as that term is used herein, are those build powders which are prone to flow problems and/or to agglomeration problems due to the fact that for them surface-related forces are no longer negligible in relation to gravitational forces. In general, fine powders have an average effective diameter of under 20 microns, although for some powder materials having high levels of surface-related forces, the average effective diameter at which they fall within this definition of fine powders is larger than 20 microns. It is to be understood that the surface-related forces do not only include forces by which one particle is inherently attracted to another, but also include the forces arising from materials which at least partially coat a particle's surface, e.g. adsorbed moisture. The solution to this problem was disclosed in U.S. patent application Ser. No. 15/161,361, which has common ownership with the instant application and a common inventor. The recoaters disclosed in that patent application were described as having primary application to fine powders although they could be used with any size or type of build powder for powder-layer three-dimensional printing. Nonetheless, some coarser powders have been found to have some difficulty being dispensed as easily by such recoaters.

### SUMMARY OF THE INVENTION

The present invention improves upon the recoaters disclosed in U.S. patent application Ser. No. 15/161,361 by modifying them to more easily dispense powders that are larger than fine powders while still retaining the ability to dispense fine powders. The inventive recoaters comprise a controllably vibrated traveling powder dispenser having a hopper section adapted to contain the build powder, an opening through which the powder can be controllably discharged laterally into a chamber which is located beside the opening and which has a mesh comprising at least a portion of its bottom. The inventive recoaters also comprise a gate adapted to control the size of the opening, the gate having a lower portion that is proximal to the opening. The recoaters also comprise a first vibrator that is operably connected to the traveling powder dispenser and is adapted to selectively cause the powder to flow from the hopper through the opening and be discharged through the mesh. Additionally, at least the bottom portion of the gate is adapted to horizontally oscillate with respect to the hopper so as to agitate at least some of the powder. These gate oscillations have the effect of enhancing the flow of powder through the opening and out through the mesh.

In some embodiments, the inventive recoaters also comprise a smoothing device which is adapted to smoothen the powder dispensed through the mesh. Examples of smoothing devices include rollers, counter-rotating rollers, doctor blades, and tamping platens. In some embodiments the smoothing device is adapted to compact the density of the dispensed powder level a selectable amount.

In some embodiments, the inventive recoaters also comprise radiant energy source which is adapted to selectably apply radiant energy to the dispensed powder and/or the powder bed.

In another aspect, the present invention also includes powder-layer three-dimensional printers having the recoaters described in the previous three paragraphs.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a schematic perspective view of an embodiment in the form of powder-layer three-dimensional printer 10.

FIGS. 2A-2C are, respectively, front, back, and bottom schematic perspective views of an embodiment recoater 22.

FIG. 3A is a schematic top view of the recoater 22 in which, for expository purposes, the top panel 32 is rendered invisible.

FIG. 3B is a closer view of the section in FIG. 3A that is outlined by a dashed line box 3B.

FIG. 4A is a schematic perspective cut-away side view of the embodiment recoater 22 sectioned along the cutting plane 4A-4A shown in FIG. 2A.

FIG. 4B is a side cutaway view of the lower portion of the powder dispenser 24 which is enclosed within the dashed-line box 4B in FIG. 4A.

FIG. 5 is a schematic perspective front view of another recoater embodiment, i.e. the recoater 90.

FIG. 6 is a perspective cut-away side view of the recoater 90 taken along the cutting plane 6-6 of FIG. 5 in which, for expository purposes, the cover 92 of the lateral powder chamber 94 of the powder dispenser 96 has been rendered invisible.

### DESCRIPTION OF PREFERRED EMBODIMENTS

Some preferred embodiments of the present invention are described in this section in detail sufficient for one skilled in the art to practice the present invention without undue experimentation. It is to be understood, however, that the fact that a limited number of preferred embodiments are described in this section does not in any way limit the scope of the present invention as set forth in the claims.

It is to be understood that whenever a range of values is described herein, i.e. whether in this section or any other part of this patent document, the range includes its end points and every point therebetween as if each and every such point had been expressly described. Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present invention.

The phrase “traveling powder dispenser” is to be understood to mean a device which is adapted to controllably traverse across a build platform or powder bed and to dispense a build powder onto the build platform or powder bed as it traverses across the build platform or powder bed.

The recoaters of the present invention have particular utility with powder-layer three-dimensional printers. Although the recoaters may be used with any type of powder-layer three-dimensional printers, for the sake of conciseness, the only type of powder-layer three-dimensional printers that will be discussed in this section are those of the binder-jetting three-dimensional printer type. The binder-jetting three-dimensional printers are also sometimes in the art referred to as “three-dimensional inkjet printers” because the binder jetting is done using a print head that resembles those developed for inkjet printing. The basic binder jetting three-dimensional printing process was invented 1980's and developed in the 1990's at the Massachusetts Institute of Technology and is described in several United States patents, including the following U.S. Pat. No. 5,387,380 to Cima et al., U.S. Pat. No. 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, U.S. Pat. No. 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., U.S. Pat. No. 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., U.S. Pat. No. 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., and 8,465,777 to Wang et al.

For ease of description the powder discharge from the inventive recoaters is described at some places herein in terms of a desired amount of powder. It is to be understood that the present invention includes controlling one or both of the amount of powder discharged from a recoater and the rate at which powder is discharged from the recoater.

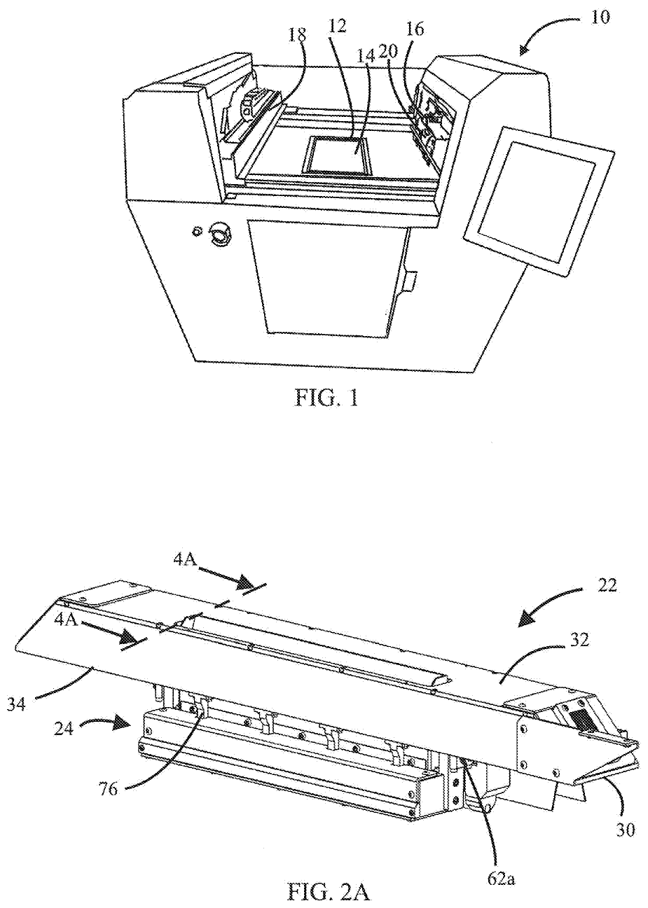

Referring now to FIG. 1, there is shown a schematic perspective view of an embodiment in the form of powder-layer three-dimensional printer 10. The powder-layer three-dimensional printer 10 includes a build box 12 having a vertically indexible build platform (not visible) and containing a powder bed 14, a recoater 16, and a selectively positionable binder-jet printing device 18. During operation, the recoater 16 is moved over the build platform or powder bed 14 to deposit a powder layer thereupon. If the recoater 16 includes a smoothing device, e.g. the smoothing device 20, the smoothing device is employed to smoothen the deposited powder to form a uniformly thick powder layer upon the pre-existing top surface of the powder bed 14. This may be accomplished during the traverse of the powder bed 14 by the recoater 16 during which the powder is dispensed or during a subsequent traverse of the powder bed 14. Another powder layer may then be deposited, if desired, or the binder-j et printing device 18 may then be moved over the powder bed 14 to selectively deposit binder onto the newly deposited layer and then moved back off to the left of the powder bed 14 to permit the deposition of the next powder layer onto the powder bed 14.

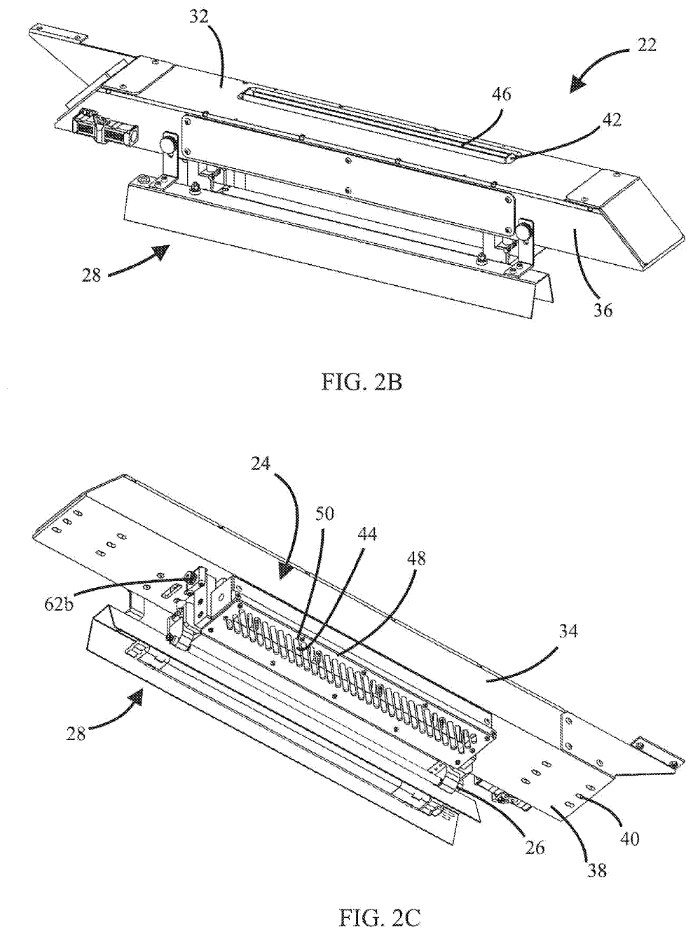

Refer now to FIGS. 2A-2C, which show, respectively, front, back, and bottom perspective views of an embodiment recoater 22. The recoater 22 includes a traveling powder dispenser 24, a smoothing device in the form of a motor driven roller assembly 26, and a radiant heater assembly 28 all of which are supported by the bridge trolley 30 so as to be able to selectively traverse a powder bed. The bridge trolley 30 in this embodiment has a box girder design which includes a top panel 32, a front side panel 34, a back side panel 36, and a bottom panel 38. The bottom panel 38 has, proximate to its ends, bolt holes, e.g. bolt hole 40, by which the bottom panel 38 is attached to a movable actuator or some other movable device (not shown) that selectably transports the rest of the bridge trolley 30 back and forth over a powder bed, e.g. powder bed 14.

The powder dispenser 24 includes a hopper 42 for containing a desired amount of a build powder (not depicted) and a mesh 44 through which the powder is selectively discharged. The hopper 42 has an inlet 46 through which powder is filled into the hopper 42. The mesh 44 is supported from sagging in this embodiment by a slotted support plate 48 and is visible in FIG. 2C only through the slots, e.g. slot 50, of support plate 48.

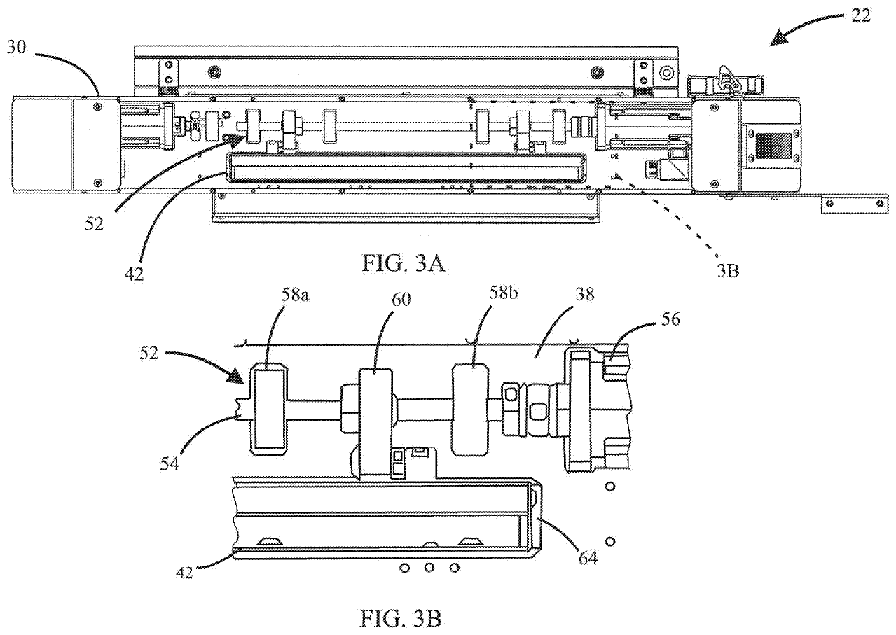

Refer now to FIG. 3A which is a schematic top view of the recoater 22 in which, for expository purposes, the top panel 32 (best seen in FIG. 2A) is rendered invisible so as to reveal the vibrator 52 which is contained within the bridge trolley 30. Refer now to FIG. 3B which provides a closer view of the section in FIG. 3A that is outlined by a dashed line box 3B. The vibrator 52 is an eccentric-type vibrator which has a drive shaft 54 driven by a selectably controllable motor 56 which is attached to the bottom panel 38. The drive shaft 54 is rotatably supported by bearing blocks, e.g. bearing blocks 58a, 58b, which are fixedly attached to the bottom panel 38. Two eccentric couples, e.g. the eccentric couple 60, are rotatably attached to the drive shaft 54 with their far ends rotatably attached to the hopper 42 of the powder dispenser 24. The powder dispenser 24 is pivotably suspended from the bridge trolley 30 by pivot bolts 62a, 62b (see FIGS. 2A and 2C, respectively). The hopper 42 passes with clearance through an opening 64 in the bottom panel 38. Operation of the motor 56 causes the eccentric couples, e.g. eccentric couple 60, by way of their attachment to the hopper 42, to rock the powder dispenser 24 back and forth upon the pivot bolts 62a, 62b. This rocking motion vibrates the powder within the hopper 42 causing the powder to laterally flow from the hopper 42 and to be discharged through the mesh 44.

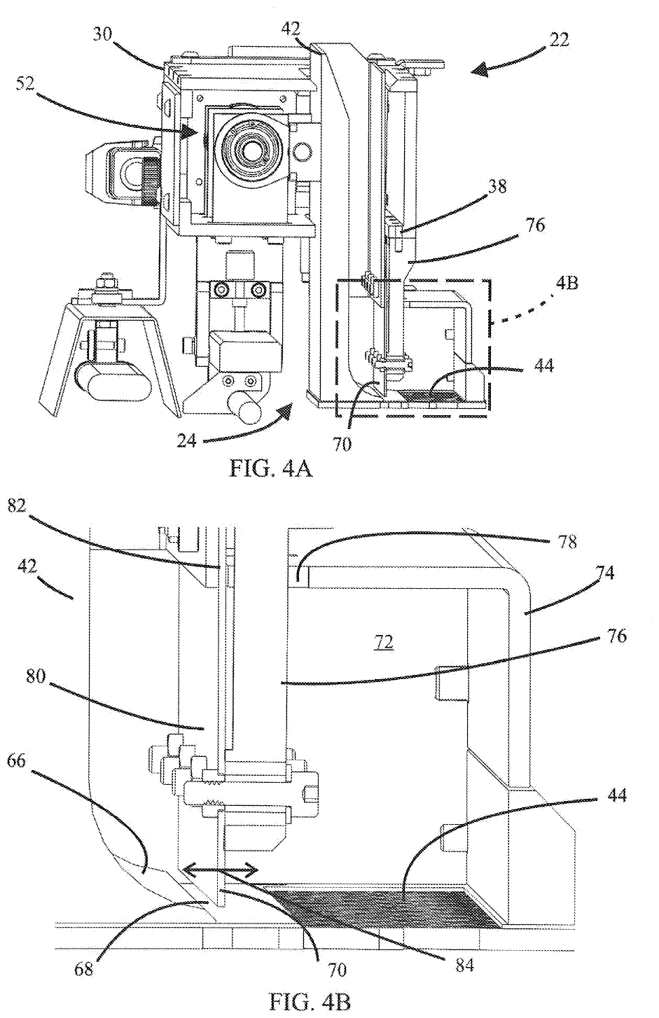

Refer now to FIGS. 4A and 4B. FIG. 4A shows a schematic perspective cut-away view of the recoater 22 sectioned along the cutting plane 4A-4A shown in FIG. 2A. FIG. 4B shows a side cutaway view of the lower portion of the powder dispenser 24 which is enclosed within the dashed-line box 4B in FIG. 4A.

As already mentioned, the powder dispenser 24 includes a powder hopper 42 adapted to contain a desired amount of powder and a mesh 44 through which the powder is selectively dispensed. The bottom portion of the powder hopper 30 has an arcuate surface 66 and a lateral opening 68. The powder dispenser 24 has a gate 70 located adjacent to the lateral opening 68 which is adapted to control the amount of powder which exits through the lateral opening 68. The gate 70 is optionally selectably controllable to enable the height of the lateral opening 68 to be selectively controlled. The powder dispenser 24 also has a chamber 72 located beside the lateral opening 68. The bottom of the chamber 72 includes the mesh 44. The powder dispenser 24 also has a chamber cover 74 which is preferably removable to facilitate cleaning the chamber 72.

Referring now to FIG. 2A, the powder dispenser includes a plurality of braces, e.g. brace 76, which are fixedly attached at their upper ends to the bottom panel 38 of the bridge trolley 30. Referring again to FIGS. 4A and 4B, each of these braces passes through an opening in the chamber cover 74, e.g. the opening 78, and is attached at its bottom end to the lower portion 80 the gate 70. The top portion 82 of the gate 70, is fixed (preferably selectively fixed) relative to the hopper 42. As described above, the powder dispenser 24 is pivotably suspended from the bridge trolley 30 by pivot bolts 62a, 62b (see FIGS. 2A and 2C, respectively) so that the operation of the vibrator 52 causes the hopper 42 to rock horizontally back and forth upon the pivot bolts 62a, 62b thus vibrating the powder and causing it to laterally flow from the hopper 42 through the lateral opening 68 and out of the powder dispenser 24 through the mesh 44. The effect of the gate 70 having its top portion 82 fixed in place relative to the hopper 42 and its bottom portion 80 attached to the bridge trolley 30 by way of the plurality of braces, e.g. the brace 76, is that when the vibrator 52 causes main portion of the powder dispenser 24 to horizontally vibrate relative to the bridge trolley 30, the bottom of the gate 80 remains stationary with respect to bridge trolley 30 and thus has a relative horizontal oscillating motion with respect to the hopper 42. The relative horizontal oscillating motion of the bottom portion 80 of the gate 70 is depicted by the double-headed arrow 84 in FIG. 4B.

The inventor of the present invention has made the surprising discovery that the addition of the horizontal oscillatory motion of the bottom portion 80 of the gate 70 with respect to the hopper 42 during the operation of the vibrator 52 agitates some of the powder and results in enhanced powder discharge from the powder dispenser 24. Without intending to be bound, the inventor speculates that the horizontal oscillatory motion of the bottom portion 80 of the gate 70 helps to prevent or mitigate transient powder bridging that occurs as the powder is flowing from the hopper 42 through the lateral opening 68.

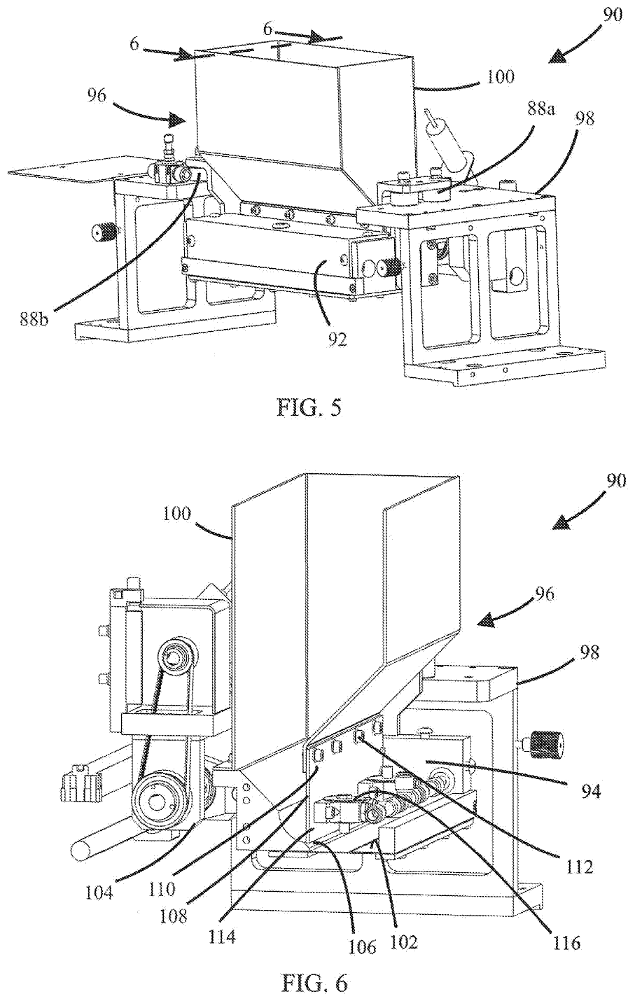

FIG. 5 is a schematic perspective front view of another recoater embodiment, i.e. the recoater 90 and FIG. 6 is a perspective cut-away view of the recoater 90 taken along the cutting plane 6-6 of FIG. 5. Note that for expository purposes, in FIG. 6 the cover 92 of the lateral powder chamber 94 of the powder dispenser 96 has been rendered invisible so that components within the lateral powder chamber 94 may be seen.

Referring to these drawings, the recoater 90 includes the traveling powder dispenser 96 supported by a bridge trolley 98 so as to be able to selectively traverse a powder bed. The powder dispenser 96 is mounted upon the bridge trolley 98 via dampening supports, e.g. the dampening supports 88a, 88b. The powder dispenser 96 includes a hopper 100 for containing a desired amount of a build powder (not depicted) and a mesh 102 through which the powder is selectively discharged. The recoater 90 also includes an eccentric vibrator 104 which is operably connected to the powder dispenser 96 so that selectively operating the vibrator 104 causes powder to flow from the hopper 100 through the opening 106, the size of which is regulated by the gate 108, and to be discharged through the mesh 102. In this embodiment, the top portion 110 of the gate 108 is fixed to the hopper 100 by a plurality of bolts, e.g. the bolt 112. The lower portion 114 of the gate 108 has attached to it a plurality of selectively operable pneumatic vibrators, e.g. the pneumatic vibrator 116, which are adapted to vibrate horizontally. Note that for clarity, the air supply lines to the pneumatic vibrators are not shown in the drawings. Operation of the pneumatic vibrators causes the lower portion 114 of the gate 108 to horizontally oscillate relative to the hopper 100 thereby agitating the powder in the hopper 100 that is the vicinity of the lower portion 114 of the gate 108. Thus, the powder dispensing operation of the recoater 90 that is provided by the operation of the vibrator 104 is enhanced by the simultaneous operation of one or more of the pneumatic vibrators, e.g. the pneumatic vibrator 116, which causes the lower portion 114 of the gate 108 to agitate some of the powder by horizontally oscillating.

The vibrator 106 is of the motor-driven eccentric type in which the motor is supported by the bridge trolley 98 and is operably attached to the powder dispenser 96. As noted above, the powder dispenser 96 is otherwise vibrationally isolated from the bridge trolley 98 by vibration dampeners, e.g. the dampening supports 88a, 88b, so as to minimize the amount of vibrational energy needed to operate the powder dispenser 30 and to prevent unnecessary wear on the vibrator components and vibration-induced fastener loosening on the bridge trolley 98. Any type of a vibration dampener known in the art may be used in embodiments to vibrationally isolate, at least in part, the powder dispenser from its trolley or other supporting transporting device. The choice of the vibration dampener to be used depends in part upon whether at the location in which it is used, the powder dispenser hangs from or is seated upon the transporting device. Nonetheless, the present invention includes embodiments in which the powder dispenser is not vibrationally isolated from its transporting support device.

In some embodiments, the height of the opening between the hopper and the powder chamber is unadjustably fixed, while in some other embodiments this height can be adjusted. In some embodiments, the opening height may be adjusted by way of adjusting the location at which the upper portion of the gate is affixed to the rest of the powder dispenser. The adjustment of the location of the upper portion of the gate can be accomplished, for example, by providing vertically spaced bolt holes or vertically slotted bolt holes in the upper portion of the gate or by attaching the gate to a controllable mechanism that raises or lowers the location and then locks the upper portion of the gate in place. In some embodiments, the adjustment of the height of the opening can be accomplished by replacing a gate of one vertical length with a gate of a different vertical length.

Although for each of the two embodiments described above in relation to the drawings, the powder hopper portion of the powder dispenser includes an arcuate surface at or near its bottom proximate to the lateral discharge opening of the powder hopper, e.g. arcuate surface 118 of powder hopper 100 (see FIG. 6), not all embodiments include such an arcuate section while others have more than one arcuate surface. Preferred embodiments include at least one arcuate surface at or near the bottom of the hopper as it is believed that such a surface aids in the lateral flow of the powder to the discharge opening. Also, although arcuate surfaces of any radius may be used embodiments, it is preferred that such arcuate surfaces have a radius of at least 1.2 centimeters when the recoater is to be used with fine powders.

The mesh is preferably sized so to allow the power dispenser to discharge the build powder across the entire width of the powder bed. In some embodiments, the mesh is sized so as to enable the recoater to discharge powder over the entire powder bed from a stationary position. The choice of mesh with regard to characteristics such as opening size and shape, material of construction, and strand size depends on the particle size distribution, particle shape, mass density, and other factors which affect the flowability of the build powder that is to be used with the inventive recoater. It is often the case that the mesh opening size may be much larger than the average particle size of the build powder as powder bridging can act to curtail powder flow through the mesh when the vibrator is turned off.

Some, but not all, recoater embodiments include a smoothing device. Examples of such smoothing devices include rollers, counter-rotating rollers, doctor blades, and tamping platens. In some embodiments, the smoothing device is adapted to compact the density of the dispensed powder level a selectable amount. Also, some, but not all recoater embodiments include a radiant energy source adapted to selectably apply radiant energy to the dispensed powder and/or the powder bed.

The present invention also includes powder-layer three-dimensional printers, e.g. the powder-layer three-dimensional printer 10 depicted in FIG. 1, which include any of the embodiments of recoaters described above.

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A recoater comprising:
a traveling powder dispenser having
(i) a hopper adapted to contain a build powder,
(ii) a first chamber having a bottom, the bottom including a mesh,
(iii) an opening adapted to controllably discharge the build powder laterally from the hopper into the first chamber, and
(iv) a gate adapted to selectively control the size of the opening, the gate having an upper portion and a lower portion, the lower portion being proximal to the opening; and
a first vibrator operably connected to the powder dispenser;
wherein the first chamber is located beside the opening and the first vibrator is adapted to selectively cause the build powder to flow from the hopper through the opening and to be discharged through the mesh and at least the lower portion of the gate is adapted to horizontally oscillate with respect to the hopper to agitate at least some of the build powder.

2. The recoater of claim 1 further comprising a second vibrator, the second vibrator being operably connected to the lower portion of the gate.

3. The recoater of claim 1 further comprising a transport support device and a vibration dampener, whereby the transport support device is adapted to transport the powder dispenser over a powder bed and the powder dispenser is at least in part vibrationally isolated from the transport support device by the vibration dampener.

4. The recoater of claim 3, wherein the lower portion of the gate is mechanically connected to the transport support device and the top portion of the gate is fixed in place relative to the hopper.

5. The recoater of claim 1 wherein the first vibrator is adapted to vibrate in an ultrasonic frequency range.

6. The recoater of claim 2 wherein the second vibrator is adapted to vibrate in an ultrasonic frequency range.

7. The recoater of claim 1 further comprising a smoothing device.

8. The recoater of claim 1 further comprising a radiant energy source.

9. A powder-layer three-dimensional printer comprising a recoater, the recoater including:
a traveling powder dispenser having
(i) a hopper adapted to contain a build powder,
(ii) a first chamber having a bottom, the bottom including a mesh,
(iii) an opening adapted to controllably discharge the build powder laterally from the hopper into the first chamber, and
(iv) a gate adapted to selectively control the size of the opening, the gate having an upper portion and a lower portion, the lower portion being proximal to the opening; and
a first vibrator operably connected to the powder dispenser;
wherein the first chamber is located beside the opening and the first vibrator is adapted to selectively cause the build powder to flow from the hopper through the opening and to be discharged through the mesh and at least the lower portion of the gate is adapted to horizontally oscillate with respect to the hopper to agitate at least some of the build powder.

10. The powder-layer three-dimensional printer of claim 9 wherein the recoater further comprises a second vibrator, the second vibrator being operably connected to the lower portion of the gate.

11. The powder-layer three-dimensional printer of claim 9 wherein the recoater further comprises a transport support device and a vibration dampener, whereby the transport support device is adapted to transport the powder dispenser over a powder bed and the powder dispenser is at least in part vibrationally isolated from the transport support device by the vibration dampener.

12. The powder-layer three-dimensional printer of claim 11 wherein the lower portion of the gate is mechanically connected to the transport support device and the top portion of the gate is fixed in place relative to the hopper.

13. The powder-layer three-dimensional printer of claim 9 wherein the first vibrator is adapted to vibrate in an ultrasonic frequency range.

14. The powder-layer three-dimensional printer of claim 9 wherein the second vibrator is adapted to vibrate in an ultrasonic frequency range.

15. The powder-layer three-dimensional printer of claim 9 wherein the recoater further comprises a smoothing device.

16. The powder-layer three-dimensional printer of claim 9 wherein the recoater further comprises a radiant energy source.
